(19) United States
(12) Patent Application Publication
(10) Pub. No.: US 2013/0243273 A1
(43) Pub. Date: Sep. 19, 2013

(54) IMAGE PUBLISHING DEVICE, IMAGE PUBLISHING METHOD, IMAGE PUBLISHING SYSTEM, AND PROGRAM

(71) Applicant: FUJIFILM CORPORATION, Tokyo (JP)

(72) Inventors: Kei YAMAJI, Tokyo (JP); Kazuhiro MINO, Tokyo (JP); Yukita GOTOHDA, Tokyo (JP); Yoshihiro YAMAGUCHI, Tokyo (JP)

(73) Assignee: FUJIFILM CORPORATION, Tokyo (JP)

(21) Appl. No.: 13/779,184

(22) Filed: Feb. 27, 2013

(30) Foreign Application Priority Data
Mar. 14, 2012 (JP) 2012-057055

(51) Int. Cl. G06T 7/00

(52) U.S. Cl. CPC G06T 7/0002
USPC 382/118; 382/100

(57) ABSTRACT

An image publishing device includes an image storage that stores images owned by a user, an image analyzer that performs image analyses on each of the images stored in the image storage, and a publishing/non-publishing decision unit that makes a publishing/non-publishing decision on each of the images based on results of the image analyses made on each of the images.

### BACKGROUND OF THE INVENTION

The present invention relates to an image publishing device, an image publishing method, an image publishing system, and a program that automatically decide on publishing or non-publishing of images owned by a user.

As the SNS (social networking service) or the like becomes widespread, images (photographs) are uploaded to servers and shared among friends and family more often than ever. On the other hand, when images are shared, there may arise a problem that, unless one is careful about the publishing settings (settings for permitting selected users to view images owned by one), one's private photographs, for example, may be made public also to any number of users known or unknown to one.

This problem may be addressed by, for example, making settings for making each image public or private (non-public) or making one whole album containing a plurality of images public or private.

JP 2003-115975 A, for example, describes an image storing device that classifies images according to customer information or image attribute information, permitting a third party to access an image belonging to a class indicated by a class readout permission information while blocking a third party's access to an image belonging to the other classes.

JP 2008-197968 A describes an event image disclosure system that adds ID data of a recording medium on which an image is stored or the ID data of a terminal used to acquire the image to the header of the image data, transmits the image data added with ID data to the server, searches for the ID data added to the image data according to browsing conditions designated in the request to view made from a user's image browsing terminal, obtains image data added with ID data that meet the browsing conditions from the server, and transmits the image data to the image browsing terminal that has made the request to view.

### SUMMARY OF THE INVENTION

However, with the device described in JP 2003-115975 A, the user himself/herself needs to make settings for each image on, for example, sharing information as image attribute information as to whether the image is to be shared with a third party. In recent years, photographing using a portable phone or a smartphone is being practiced daily with an increasing frequency, and there arises a problem that making publishing/non-publishing settings for each photograph each time a number of photographs are taken requires much work.

On the other hand, while the device described in JP 2008-197968 A has an advantage of being able to make publishing/non-publishing settings on each image owned by a user, and the user himself/herself need not make the publishing/non-publishing settings, the device has a drawback of being unable to control publishing/non-publishing of each image.

An object of the present invention is to overcome the above problems encountered in the prior art and provide an image publishing device, an image publishing method, an image publishing system, and a program each capable of automatically deciding on publishing or not publishing each image according to given rules without the need for the user to make settings on publishing or non-publishing.

To achieve the above object, the present invention provides an image publishing device comprising:

an image storage adapted to store images owned by a user,

an image analyzer adapted to make image analyses on each of the images stored in the image storage, and

a publishing/non-publishing decision unit adapted to decide to publish or not to publish each of the images based on results of the image analyses made on each of the images by the image analyzer.

Further, the present invention provides an image publishing system comprising:

a communication terminal having a communication function, and

the image publishing device according to claim 1 that is connected to the communication terminal via a network,

wherein the image storage is adapted to store an image uploaded from the communication terminal via the network.

Further, the present invention provides an image publishing method comprising:

an image storing step of storing images owned by a user in an image storage,

an image analysis step of performing image analyses on each of the images stored in the image storage, and

a publishing/non-publishing decision step of making a publishing/non-publishing decision on each of the images based on results of the image analyses made on each of the images.

Further, the present invention provides a non-transitory computer readable recording medium having recorded thereon a program adapted to cause a computer to execute each step of the image publishing method described above.

The present invention automatically decides to publish or not to publish an image based on the results obtained from a plurality of image analyses including the total score obtained from the results of a plurality of image analyses, the result of the face detection, the result of the similar image judgment, and the result of the event classification. Therefore, images a user desires to publish can be made public to other users (shared with other users) via a network such as the Internet without the need for the user to make settings on publishing/non-publishing of images.

### BRIEF DESCRIPTION OF THE DRAWINGS

FIG. 1 is a conceptual view illustrating a configuration of an embodiment of an image publishing system of the invention.

FIG. 2 is a block diagram illustrating a configuration of an image management server shown in FIG. 1.

FIG. 3 is a conceptual view illustrating image analyses performed by the image analyzer shown in FIG. 2.

FIG. 4 is a conceptual view illustrating how face detection is performed.

FIG. 5 is a conceptual view illustrating how brightness judgment is performed.

FIGS. 6A and 6B are conceptual views illustrating how color evaluation is performed.

FIG. 7 is a conceptual view illustrating how event classification and similar image judgment are performed.

FIGS. 8A and 8B are conceptual views illustrating how a given portion is cut out of an image.

FIGS. 9A and 9B are conceptual views illustrating how images containing persons are reduced in size.

### DETAILED DESCRIPTION OF THE INVENTION

The image publishing device, image publishing method, image publishing system, and program of the invention are described below in detail with reference to preferred embodiments shown in the accompanying drawings.

First, the configuration of the image publishing system will be described.

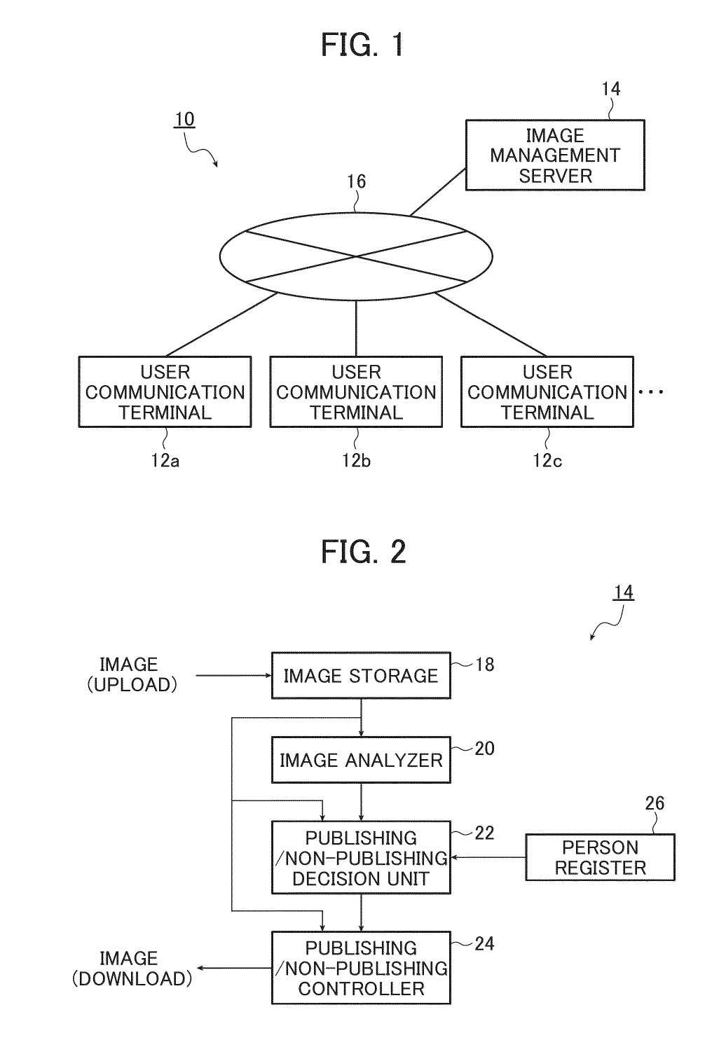

FIG. 1 is a conceptual view of a configuration of an embodiment of the image publishing system of the invention. An image publishing system 10 illustrated in that view is provided to publish images owned by a user to another user (share the image with another user) through a network 16 such as the Internet and comprises a plurality of user communication terminals 12a, 12b, . . . (which may hereinafter be referred to simply as user communication terminal or terminals 12), and an image management server (image publishing device) 14.

The user communication terminals 12 are used respectively by users who use the image publishing system 10 to upload images owned by the individual users from the user communication terminals 12a, 12b, . . . via the network 16 to the image management server 14 and make a request to view an image uploaded to the image management server 14 to download the image to the respective user communication terminals 12a, 12b, . . . via the network 16 in order to, for example, view the image.

The user communication terminals 12 are, for example, mobile terminals such as portable phones and smartphones equipped with functions of, for example, a camera and a GPS (global positioning system) or desk-top PCs (personal computers), notebook PCs, tablet PCs, and the like, having a function of loading image data of images (photographs) from, for example, a camera and performing editing, viewing, and the like. The user communication terminals 12 have a communication function whereby images are uploaded and downloaded between the user communication terminals 12 and the image management server 14 via the network 16.

The image management server 14 performs image analyses on each image uploaded from any of the user communication terminals 12a, 12b, . . . via the network 16 to decide to publish or not to publish the image based on the results of the image analyses and comprises an image storage 18, an image analyzer 20, a publishing/non-publishing decision unit 22, a publishing/non-publishing controller 24, and a person register 26 as illustrated in FIG. 2.

The image storage 18 stores images owned by the users and uploaded from the user communication terminals 12a, 12b, . . . via the network 16 (stored are therefore digital image data).

The image analyzer 20 performs a plurality of image analyses on each image and allots a score to the result of each image analysis made on each image to calculate a total score from the results of the image analyses.

The image analyzer 20 may perform image analyses on each image stored in the image storage 18 or may perform image analyses on each image acquired, for example, by means of the camera function of the user communication terminals 12.

The person register 26 registers a person (user) who desires to publish an image showing himself/herself.

The person register 26 is not an essential constituent. The person register 26 may also register a person who desires to make private an image showing himself/herself or may register both a person who desires to make public an image showing himself/herself and a person who desires to make private an image showing himself/herself.

The publishing/non-publishing decision unit 22 decides to publish or not to publish each image based on the results of the image analyses made on each image by the image analyzer 20 and information on the persons registered in the person register 26 (registered persons).

The publishing/non-publishing decision unit 22 may decide to publish or not to publish each image stored in the image storage 18 or may decide to publish or not to publish each image acquired, for example, by means of the camera function of the user communication terminals 12.

In this embodiment, the publishing/non-publishing decision unit 22 decides to publish an image showing a person registered in the person register 26 according to the result of the image analyses. On the other hand, when the person register 26 registers a person who desires to make private an image showing himself/herself, the publishing/non-publishing decision unit 22 decides not to publish an image showing a person registered in the person register 26 according to the result of the image analyses.

The publishing/non-publishing controller 24 controls publishing and non-publishing of each image stored in the image storage 18 according to the publishing/non-publishing decision made by the publishing/non-publishing decision unit 22 in response to a request to view made from any of the user communication terminals 12. In other words, the publishing/non-publishing controller 24 controls permission and nonpermission of downloading of an image for which a request to view is made from the user communication terminal 12 that has made the request to view.

Next, an outline of the operation of the image publishing system 10 will be described based on the image publishing method of the invention.

In the image publishing system 10 illustrated in FIGS. 1 and 2, images owned by the respective users are uploaded from the user communication terminals 12a, 12b, . . . used by the respective users via the network 16 to the image management server 14.

In the image management server 14, the images uploaded from the user communication terminals 12a, 12b, . . . are stored in the image storage 18.

The image analyzer 20 then performs image analyses on each of the images stored in the image storage 18, and the publishing/non-publishing decision unit 22 decides to publish or not to publish each image stored in the image storage 18 according to the results of the image analyses made by the image analyzer 20 on each image and the information on the persons registered in the person register 26.

Thereafter, when a request to view is made for an image uploaded from any of the user communication terminals 12a, 12b, . . . to the image management server 14, the publishing/non-publishing controller 24 controls publishing and non-publishing of each image stored in the image storage 18 according to the publishing/non-publishing decision made by the publishing/non-publishing decision unit 22.

The publishing/non-publishing controller 24 permits a user communication terminal 12 that has made a request to view an image, for which a decision on publishing has been made, to download the image. In this case, the user can view the image on the user communication terminal 12 from which he/she has made the request to view. By contrast, the publishing/non-publishing controller 24 does not permit a user communication terminal 12 that has made a request to view an image, for which a decision on non-publishing has been made, to download the image. In this case, the user cannot view the image on the user communication terminal 12 from which he/she has made the request to view.

The image publishing system 10 automatically decides to publish or not to publish each image according to the results of a plurality of image analyses made on each image. The user therefore can be saved the trouble of making settings on publishing and non-publishing of each image.

Next, the image analyses made by the image analyzer 20 will be described.

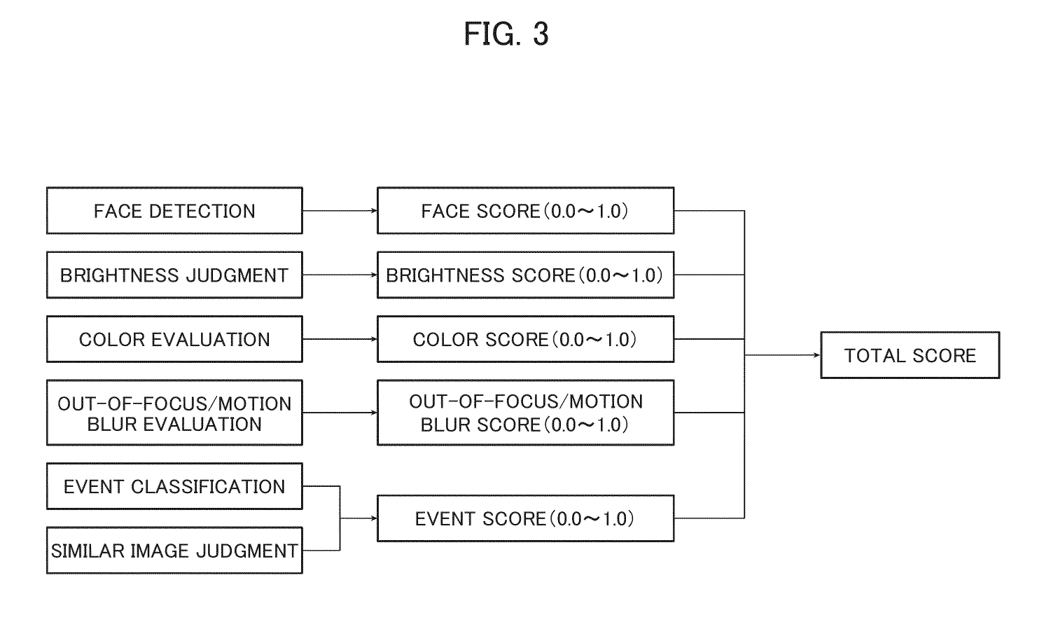

The image analyzer 20 performs a plurality of image analyses including, for example, face detection, brightness judgment, color evaluation, out-of-focus blur and motion blur (caused by relative movement between camera and object) evaluation, event classification, and similar image judgment as illustrated in FIG. 3.

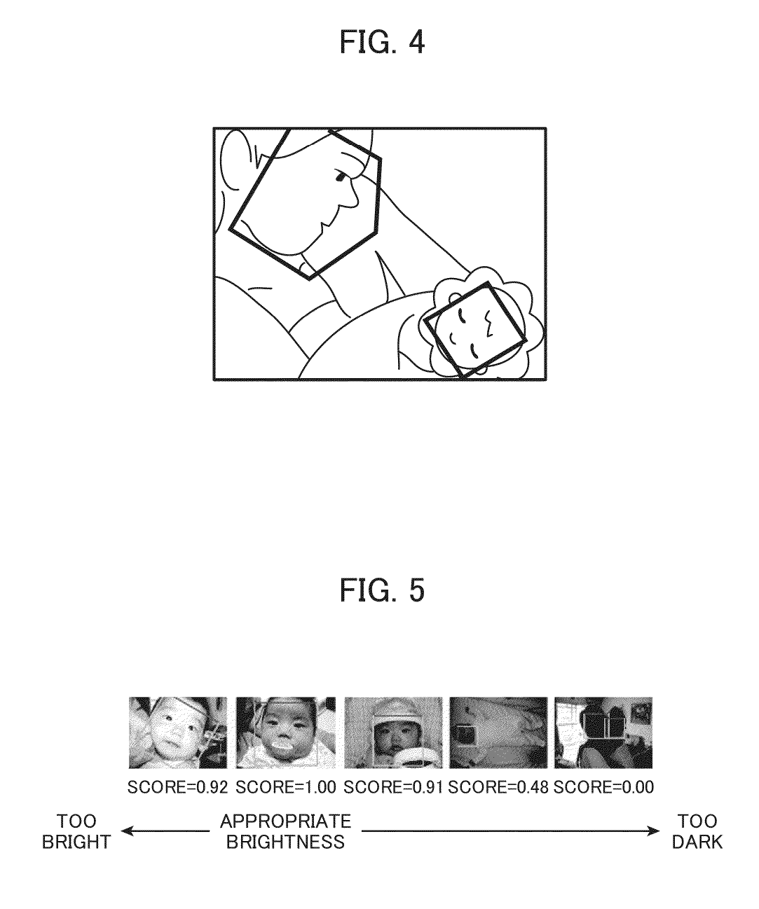

The face detection is a processing for detecting, for example, the number of the faces of persons (face regions), the sizes of the faces, the directions in which the faces are directed, and the positions of the faces contained in an image as indicated by frames in FIG. 4.

By performing the face detection, the image analyzer 20 judges an image to have a high degree of importance when, for example, the image contains a large number of faces, when the image contains a large face, when the image contains a face that is directed frontward, or when the image contains a face that is positioned centrally in the image, and gives a high face score in the evaluation made as a result of the face detection.

The brightness judgment is a processing for evaluating the degree of brightness of an image with respect to a given region such as, for example, the whole image or a face region detected by the face detection.

In the brightness judgment, the image analyzer 20 judges the brightness of, for example, a face region detected by the face detection and gives a brightness score of 1.0 in the evaluation made as a result of the brightness judgment when the brightness of the face region is appropriate, lowering the brightness score when the region is excessively bright or dark, as illustrated in FIG. 5.

When the brightness judgment is made this way, the brightness score can be given only to an image containing a face. Therefore, the brightness judgment may be made in such a manner, for example, that when an image contains a face, the brightness score is determined as above, whereas when an image does not contain a face, the brightness score may be determined based on the result of the brightness judgment on the whole image.

The color evaluation is a processing for evaluating the tint of an image with respect to a given region such as, for example, the whole image or a face region.

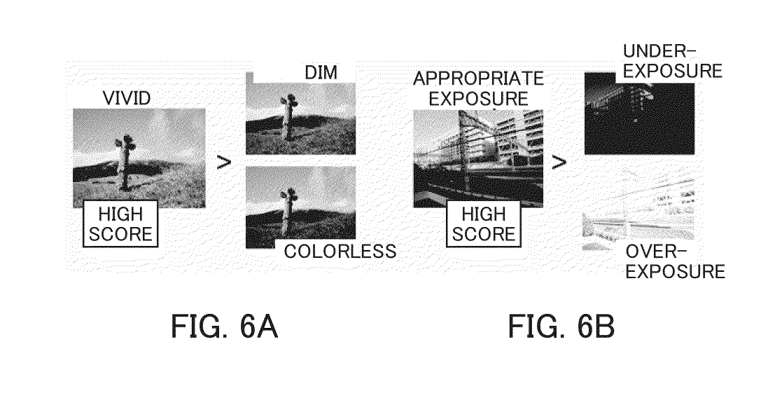

As a result of the color evaluation, the image analyzer 20 gives a relatively high color score to an image in the evaluation made as a result of the color evaluation when, for example, the color of the image is vivid, and gives a relatively low score when the color is dim, or when the image is colorless, as illustrated in FIG. 6. When the exposure of an image is appropriate, a relatively high color score is given; for an underexposed or overexposed image, a relatively low color score is given.

The out-of-focus/motion blur evaluation is a processing for evaluating the degree of an out-of-focus blur and a motion blur in each image.

When no out-of-focus/motion blur is detected as a result of the out-of-focus/motion blur evaluation, the image analyzer 20 gives an out-of-focus/motion blur score of 1.0 in the evaluation made as a result of the out-of-focus/motion blur evaluation, lowering the score depending on the degree of out-of-focus/motion blur.

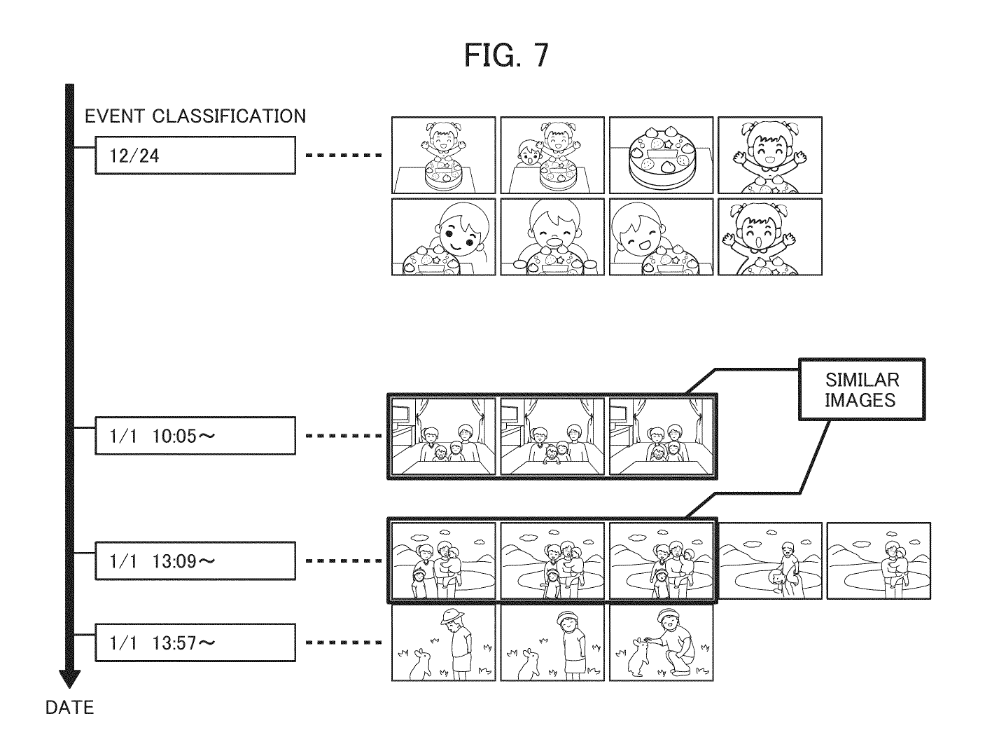

As illustrated in FIG. 7, the event classification is a processing for classifying (grouping) an image by, for example, event according to the date at which the image was taken, the event being, for example, a birthday party or a field day, and the similar image judgment is a processing for detecting similar images classified, for example, by event into a group.

As a result of the event classification and the similar image judgment, the image analyzer 20 judges an event to be an important event when, for example, a large number of images were taken in the event, when images taken in the event contain a large number of faces of persons detected, or when a large number of similar images were taken in the event and gives a high event score in the evaluation made as a result of the event classification and the similar image judgment.

The similar image judgment may detect similar images among not only images classified by event but images included in any group such as images classified by user or images uploaded simultaneously.

The above image analyses are known in the art and any of the known image analysis methods may be used in the present invention. A detailed description of the processing methods therefore is not herein included. The image analyzer 20 may perform other image analyses than are described above.

As illustrated in FIG. 3, the image analyzer 20 determines the face score, the brightness score, the color score, the out-of-focus/motion blur score, and the event score in a range of 0.0 to 1.0 respectively based on the results of the image analyses including the face detection, the brightness detection, the color evaluation, the out-of-focus/motion blur evaluation, the event classification, and the similar image judgment and calculates a total score from the results of the image analyses.

The total score may be calculated by adding up the results that are obtained by multiplying the scores yielded by the respective image analyses by given weighting coefficients. In this embodiment, the total score is calculated using a formula (I) below, where the score given as a result of the face detection is alloted a greatest weight, the face weighting coefficient being 1.00, the brightness weighting coefficient 0.05, the color weighting coefficient 0.10, the out-of-focus/motion blur weighting coefficient 0.05, and the event weighting coefficient 0.20.

Total score=face score×face weighting coefficient+brightness score×brightness weighting coefficient+color score×color weighting coefficient+out-of-focus/motion blur score×out-of-focus/motion blur weighting coefficient+event score×event weighting coefficient (1)

Table 1 shows an example of the results of the image analyses by the image analyzer 20. Table 1 shows the total scores, the result of the face detection, presence/absence of a registered person, and the result of the similar image judgment for images A, B, C, D, . . . .

In the example shown in Table 1, faces are detected in the images A, C, and D; registered persons are detected in the images C and D; and the images C and D are judged to be similar images. The formula (1) gives total scores based on the results of the image analyses. As will be seen, the images C, B, A, and D are given respectively total scores descending in this order.

TABLE 1

| | | Face | Registered | | |
|---|---|---|---|---|---|
| | Total Score | Detection | Person | Similar Images | . . . |
| Image A | 334 | ∘ | Absent | None | . . . |
| Image B | 545 | x | — | None | . . . |
| Image C | 783 | ∘ | Present | Images C and D | . . . |
| Image D | 234 | ∘ | Present | Images C and D | . . . |
| . . . | . . . | . . . | . . . | . . . | . . . |

Next, the decision on publishing/non-publishing of each image made by the publishing/non-publishing decision unit 22 will be described.

The publishing/non-publishing decision unit 22 decides to publish or not to publish each image stored in the image storage 18 according to the results of the image analyses made by the image analyzer 20 including, for example, the total score, the result of the face detection, the result of the similar image judgment, and the result of the event classification.

Where the decision on publishing or non-publishing of an image is made using the total score, the publishing/non-publishing decision unit 22 decides to publish the image when, for example, the total score of the image is not less than a given value. When an image has a total score that is not less than a given value, judgment is made that the image has a high degree of importance, such an image being exemplified by an image containing a face and an image that is desirable in, for example, brightness, color, and the degree of out-of-focus/motion blur, and a decision is made to publish the image that is appropriate for publishing in terms of the image contents as exemplified above with which the image was taken.

Where, in the example shown in Table 1, the publishing/non-publishing decision unit 22 decides to publish an image when the image has a total score of 500 or more, the unit 22 decides to publish the image B having a total score of 545 and the image C having a total score of 783.

The given value of the total score may be arbitrarily determined. The publishing/non-publishing decision unit 22 may decide to publish an image having a total score not greater than the given value.

When using the result of the face detection, the publishing/non-publishing decision unit 22 decides not to publish an image showing a person to respect his/her privacy and decides to publish an image of, for example, a landscape not including a person.

In the example shown in Table 1, images indicated by “O” as a result of the face detection are images in which a face was detected; an image indicated by “X” as a result of the face detection is an image in which a face was not detected. In this case, the publishing/non-publishing decision unit 22 decides to publish the image B indicated by “X” (image of a landscape) as a result of the face detection.

The publishing/non-publishing decision unit 22 may alternatively decide to publish an image showing a person.

When the image analyzer 20 is adapted to perform, for example, a smile detection (see, for example, JP 2009-10776 A) to detect a smile of a person shown in each image, the publishing/non-publishing decision unit 22 may decide, based on the result of the smile detection, to publish an image showing a desirable facial expression such as an image with a smile, while deciding not to publish an image showing an odd facial expression such as an image showing a face with the eyes closed.

Further, when the image analyzer 20 is adapted to perform a person recognition to recognize a person shown in each image, the publishing/non-publishing decision unit 22 may decide, based on the result of the person recognition, to publish an image showing a person registered in the person register 26 such as an image showing oneself or, conversely, may decide not to publish an image showing a registered person.

Where, as in this embodiment, persons who desire to publish images containing themselves are registered in the person register 26, where an image 1 contains persons a and b while an image 2 contains persons a and c, and where the person register 26 has the persons a, b, and c registered, the image 1 is published only to the persons a and b (can be viewed only by the persons a and b) while the image 2 is published only to the persons a and c (can be viewed only by the persons a and c).

In the example shown in Table 1, the publishing/non-publishing decision unit 22 decides to publish the images C and D each indicated by “O” as a result of the face detection and judged to show a person registered in the person register 26 by the person recognition.

When using the result of the similar image judgment, the publishing/non-publishing decision unit 22 decides to publish, for example, one recommendable image selected from among a plurality of similar images, e.g., only the image having the highest total score and decides not to publish the other images.

In the example shown in Table 1, the publishing/non-publishing decision unit 22 decides to publish the image C, which has the highest total score among the similar images C and D.

When using the result of the event classification, the publishing/non-publishing decision unit 22 decides to publish, for example, only one image from among a plurality of images included in the same event, e.g., the image having the highest total score and decides not to publish the other images.

Further, when the image analyzer 20 is adapted to perform character recognition to recognize characters shown in each image, the publishing/non-publishing decision unit 22 may decide, based on the result of the character recognition, not to publish an image when the image shows information related to personal information, such as license plate number, house name plate, name of the house, and room number.

Further, the image management server 14 may be provided with an image processor that performs image processing on an image including at least one of trimming, size control, and unsharpening and perform image analyses on an image having undergone the image processing by the image processor to decide to publish or not to publish that image.

Where the image processor performs the trimming, and an image contains a portion that is not to be published, the image processor cuts out another portion of the image that may be published by trimming, whereupon the image analyses are made and a decision on publishing/non-publishing is made on the cut-out image as described above.

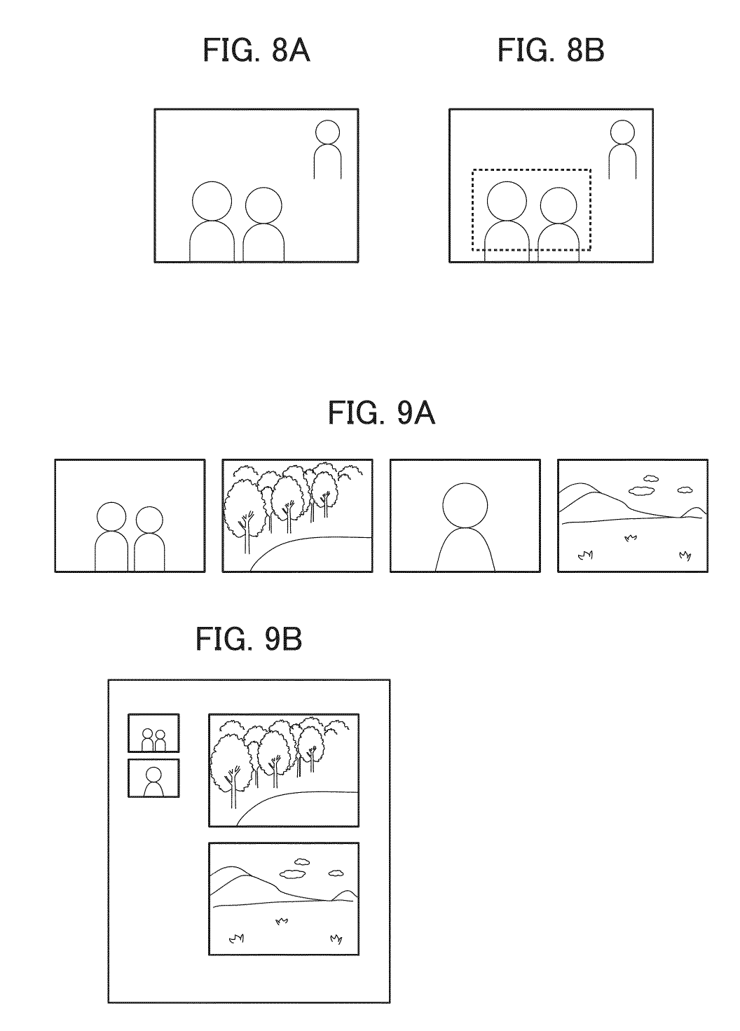

When, for example, an image showing a plurality of persons shows a person, unknown to one, behind them as illustrated in FIG. 8A, a portion not containing the unknown person is cut out as illustrated in FIG. 8B (portion indicated by a dotted line in FIG. 8B) to publish only a portion of the image showing only the persons known to one.

Where the image processor performs the size control, and an image contains a portion that is not to be published, the image processor reduces the image in size to such a degree that recognition of that portion is no longer possible, whereupon the image analyses are made and a decision on publishing/non-publishing is made on the size-reduced image as described above.

Where there are images respectively containing, for example, persons, a landscape, a person, and a landscape as illustrated in FIG. 9A, the user may not wish to publish images containing persons. In such a case, instead of simply choosing not to publish these images, the image processor may reduce the images to sizes such that recognition of the faces of the persons is no longer possible as illustrated in FIG. 9B.

Where the image processor performs the unsharpening, and an image contains a portion that is not to be published, the image processor unsharpens the image by performing blurring or pixelization on the portion of the image, whereupon the image analyses are made and a decision on publishing/non-publishing is made on the unsharpened image as described above.

Any of the above processings renders an image containing a portion not to be made public publishable and enables efficient use of the image.

Instead of making a 2-way decision permitting either publishing or non-publishing, the publishing/non-publishing decision unit 22 may be adapted to make a 3-way decision or a decision allowing a choice from more than three modes of publication/non-publication of each image.

Where a 3-way publishing/non-publishing decision is allowed, whereby an image is published to the public in general (published to any number of persons, known or unknown to one), an image is published with restrictions (published to limited persons such as friends), or an image is made private, the settings may be made such that an image having a high total score (an image with a total score that is not less than a first given value) is made open to the public in general, an image having a medium total score (an image with a total score that is smaller than the first given value and greater than a second given value (first given value>second given value)) is published with restrictions, and an image having a low total score (an image having a total score that is not greater than the second given value) is made private.

The publishing/non-publishing decision unit 22 may add information on publishing/non-publishing of each image as tag information to the image data of each image, for example, to Exif data in the header of the image data, so that the publishing/non-publishing controller 24 may be able to control the publishing/non-publishing of each image according to the tag information of each image.

The information on publishing/non-publishing stored as tag information may be information determined by the publishing/non-publishing decision unit 22 or information on publishing/non-publishing that is set by a user with a camera or viewer software. For example, when an image is shot using a camera equipped with a touch panel, the user himself/herself may manually make the publishing/non-publishing settings of each image during image preview by operating the buttons on the touch panel, or the camera may be set by default so that each image that is shot is fixedly set to publishing or non-publishing.

Further, upon shooting, an image on which a decision on publishing has been made or a decision on non-publishing has been made depending on the results of the image analyses may be displayed together with information on a publishing/non-publishing decision made on the monitor of, for example, a camera (user communication terminal 12) to provide the user with operation assistance such that the user may finally decide on publishing/non-publishing of each image. In this case, the user reviews on the monitor unit an image on which a decision on publishing has been made or an image on which a decision on non-publishing has been made by the publishing/non-publishing decision unit 22 and finally decides on the publishing or non-publishing of the image, whereupon the publishing/non-publishing decision unit 22 incorporates information on the publishing/non-publishing of each image on which the user decided as the tag information.

The user's preferences related to publishing/non-publishing based on the information of the user's final decision on publishing/non-publishing may be stored in a database. Thus, the publishing/non-publishing decision unit 22 can automate decision on publishing/non-publishing of each image according to the user's preferences based on the user's preferences stored in the database.

Further, the tag information may include a user ID in addition to the information on publishing/non-publishing. The user ID, which may be, for example, a unique value such as the serial number or the manufacturing number of a camera, and information on viewer software and storage, is incorporated as tag information on an image that is uploaded to an SNS site. Using the user ID contained in the tag information, control may be had to preclude the information on publishing/non-publishing that is set using, for example, one's (first user's) camera from being edited (changed) using another person's (second user's) viewer software.

When viewing (publishing) images on a mobile terminal (user communication terminal 12) such as a smartphone or a tablet PC outside his/her domicile, the user may not wish another person around him/her to see, for example, his/her private images or the user may be otherwise concerned about whether another person is looking in the mobile terminal. The same applies not only to an image that is downloaded from the image management server 14 to a mobile terminal via the network 16 but to an image stored in a storage of a mobile terminal.

To address the problem, conditions for restricting the publishing/non-publishing of each image (publishing conditions) may be set based on a mobile terminal location information, i.e., user location information, obtained from GPS information acquired using the GPS function of the mobile terminal.

Where the publishing of each image is limited by setting publishing conditions based on the user location information, restriction may be so effected, for example, that all the images are published when the user accesses the images in his/her domicile (no conditions set), whereas strict publishing conditions are set for mobile terminals used outside the user's domicile (limited access).

The image publishing conditions may be varied depending on location. Where, for example, there are any number of known or unknown persons around as on a train, the access to an image from a mobile terminal may be strictly limited (image publishing conditions are made strict). On the other hand, where there are only acquaintances near around as in a friend's domicile, in a park, or in a car, the access restriction is made small (image publishing conditions are relaxed). In a location like his/her own domicile, unlimited access may be allowed.

Table 2 below shows an example where access restrictions are switched according to location information. Table 2 shows an example of access restrictions (image publishing conditions) depending on the location from which the access is made, including one's own domicile, friend's domicile, and train, set for the user (user's mobile terminal) and another person (another person's mobile terminal).

TABLE 2

| | | |
|---|---|---|
| | Oneself | Another person than oneself |
| | (one's own mobile terminal) | (another mobile terminal |
| | | than his/her own) |
| One's | Access limitation: none | Access limitation: small |
| domicile | All the images published | Total score: 500 or more |
| | | Face-detected images: |
| | | published are images not |
| | | containing a registered |
| | | person not to be published |
| Friend's | Access limitation: small | Access limitation: medium |
| domicile | Total score: 500 or more | |
| | Face-detected images: | |
| | published are only images | |
| | containing a registered | |
| | person (e.g. friend) | |
| Train | Access limitation: medium | Access limitation: great |
| | Total score: 800 or more | |
| | Face-detected images: not | |
| | published | |

In the example shown in Table 2, when one views an image (on his/her mobile terminal) in his/her domicile, all the images are published without access restrictions. When the user is in a friend's domicile, the access restriction is set to small, and with friend's domicile location information and friend's face information registered in correlation to each other, images showing the face of a registered person (e.g., friend) are published from among images having a total score of 500 or more and having a person's face detected. When the user is on the train, the access restriction is set to medium, and images having a total score of 800 or more and having no face of a person detected are published.

When another person than one accesses one's images (using a mobile terminal owned by another person than one), because a person visiting the user's domicile may be supposed to know the user to some extent, the access restriction is set to small such that, from among images having a total score of 500 or more and having a face detected therein, images other than those showing a person designated to be made private are published. For example, in a friend's domicile, the access restriction is set to medium; on a train, the access restriction is set to strict.

Further, any area such as elementary school or preparatory school may be set as area for publication (an area where publication may be allowed). Where, for example, an elementary school is set as an area for publication, a decision is made such that specific images are published only while one (e.g., an elementary schooler) is at school. Thus, the user may have control as to, for example, switching images to be made public according to the place where one is located, i.e., according to the friend near one. An area for which no publication is made (area to which publication is prohibited) may be set.

The access restrictions may be changed according to display size in addition to location information. That is, a smartphone has a small display screen; a tablet PC has a larger display screen than a smartphone, increasing the chance of an image being viewed being seen by a person near him/her. To address the problem, the settings of access restrictions (image publishing conditions) may be changed according to the display size of the screen of a mobile terminal. For example, when the display size is large, the access restriction is set to great; when the display size is small, the access restriction is set to small.

As described above, the image publishing system 10 automatically decides on publishing or non-publishing of each image based on the results obtained from a plurality of image analyses including the total score obtained from the results of a plurality of image analyses, the result of the face detection, the results of the similar image judgment, and the result of the event classification. Therefore, an image a user desires to made public can be published to another user (shared with another user) via the network 16 such as the Internet without the need for the user to make settings on publishing or non-publishing of each image.

While, in the above embodiment, the image management server 14 comprises the image storage 18, the image analyzer 20, the publishing/non-publishing decision unit 22, the publishing/non-publishing controller 24, and the person register 26, the invention is not limited this way. The image storage 18, the image analyzer 20, the publishing/non-publishing decision unit 22, and the person register 26, for example, may be mounted in each of the user communication terminals 12 or may be provided in another device or a server except for the user communication terminals 12 and the image management server 14.

Where, for example, the image storage 18, the image analyzer 20, and the publishing/non-publishing decision unit 22 are mounted in the user communication terminals 12, the user communication terminals 12 can decide to publish or not to publish each image. Thus, the user communication terminals 12 can upload via the network 16 only the images which the publishing/non-publishing decision unit 22 has decided to publish to, for example, a known server for publishing images.

The image publishing method of the invention can be implemented by means of, for example, a program for causing a computer to execute each step of the image publishing method. The program may be provided, for example, recorded on a computer readable recording medium.

This invention is basically as described above.

While the present invention has been described above in detail, the invention is not limited to the above embodiments, and various improvements and modifications may be made without departing from the spirit and scope of the invention.

We claim:

1. An image publishing device comprising:
an image storage adapted to store images owned by a user,
an image analyzer adapted to make image analyses on each of the images stored in the image storage, and
a publishing/non-publishing decision unit adapted to decide to publish or not to publish each of the images based on results of the image analyses made on each of the images by the image analyzer.

2. The image publishing device according to claim 1,
wherein the image analyzer is adapted to allot a score to each of the results of the image analyses made on each of the images and calculate a total score from respective scores of the results of the image analyses, and
wherein the publishing/non-publishing decision unit is adapted to decide to publish or not to publish each of the images based on the total score calculated by the image analyzer.

3. The image publishing device according to claim 2,
wherein the publishing/non-publishing decision unit is adapted to decide to publish an image given the total score that is not smaller than a given value.

4. The image publishing device according to claim 1,
wherein the image analyzer is adapted to perform face detection for detecting a face of a person shown in each of the images as the image analyses, and
wherein the publishing/non-publishing decision unit is adapted to decide to publish or not to publish each of the images based on a result of the face detection by the image analyzer.

5. The image publishing device according to claim 4,
wherein the publishing/non-publishing decision unit is adapted to decide to publish an image containing no person and not to publish an image containing a person based on the result of the face detection by the image analyzer.

6. The image publishing device according to claim 4,
wherein the image analyzer is adapted to perform smile detection for detecting a smile of a person shown in each of the images as the image analyses, and
wherein the publishing/non-publishing decision unit is adapted to decide to publish or not to publish each of the images based on a result of the smile detection by the image analyzer.

7. The image publishing device according to claim 4,
further comprising a person register that registers a user who desires to publish an image showing himself/herself,
wherein the image analyzer is adapted to perform person recognition for recognizing a person shown in each of the images as the image analyses, and
wherein the publishing/non-publishing decision unit is adapted to decide to publish an image containing a user registered in the person register based on a result of the person recognition by the image analyzer.

8. The image publishing device according to claim 1,
wherein the image analyzer is adapted to perform similar image judgment for detecting similar images as the image analyses, and
wherein the publishing/non-publishing decision unit is adapted to decide to publish or not to publish each of the images based on a result of the similar image judgment by the image analyzer.

9. The image publishing device according to claim 8,
wherein the image analyzer is adapted to allot a score to each of the results of the image analyses made on each of the images and calculate a total score from scores of the results of the image analyses, and
wherein the publishing/non-publishing decision unit is adapted to decide to publish an image having a highest total score calculated by the image analyzer among similar images detected by the image analyzer.

10. The image publishing device according to claim 1,
wherein the image analyzer is adapted to perform event classification on the images whereby the images are classified by event based on a date on which each of the images was shot as the image analyses, and
wherein the publishing/non-publishing decision unit is adapted to decide to publish one image among images classified under a same event based on a result of the event classification performed by the image analyzer.

11. The image publishing device according to claim 10,
wherein the image analyzer is adapted to allot a score to each of the results of the image analyses made on each of the images and calculate a total score from the results of the image analyses, and
wherein the publishing/non-publishing decision unit is adapted to decide to publish one image having a highest total score among images classified under the same event.

12. The image publishing device according to claim 1,
wherein the image analyzer is adapted to perform character recognition for recognizing characters shown in each of the images as the image analyses, and
wherein the publishing/non-publishing decision unit is adapted to decide not to publish an image containing the user's personal information based on a result of the character recognition by the image analyzer

13. The image publishing device according to claim 1,
further comprising an image processor adapted to perform image processing on each of the images,
wherein the image analyzer is adapted to perform the image analyses on an image having undergone the image processing by the image processor.

14. The image publishing device according to claim 13,
wherein the image processor is adapted to perform the image processing, which is trimming whereby, when the image contains a portion not to be published, another portion that may be published is cut out.

15. The image publishing device according to claim 13,
wherein the image processor is adapted to perform the image processing, which is size reduction whereby, when the image contains a portion not to be published, the image is reduced to a size in which the portion is no longer recognizable.

16. The image publishing device according to claim 13,
wherein the image processor is adapted to perform the image processing, which is unsharpening, whereby, when the image contains a portion not to be published, the image processor unsharpen the image by blurring or pixelizing the portion.

17. The image publishing device according to claim 1,
wherein the publishing/non-publishing decision unit is adapted to make a publishing/non-publishing decision on each of the images in settings allowing at least three modes of publication/non-publication.

18. The image publishing device according to claim 17,
wherein the publishing/non-publishing decision unit is adapted to make the publishing/non-publishing decision on each of the images in settings allowing three modes of publication/non-publication including general publication whereby the image is made public to any number of unspecified persons, limited publication whereby the image is made public only to specified persons, and non-publication.

19. The image publishing device according to claim 1,
wherein the image storage, the image analyzer, and the publishing/non-publishing decision unit are mounted in a communication terminal having a communication function.

20. The image publishing device according to claim 19,
wherein the communication terminal is adapted to upload only an image which the publishing/non-publishing decision unit has decided to publish via a network to a server publishing images.

21. An image publishing system comprising:
the communication terminal recited in claim 19, and
a server adapted to publish images uploaded from the communication terminal via a network.

22. An image publishing system comprising:
a communication terminal having a communication function, and
the image publishing device according to claim 1 that is connected to the communication terminal via a network,
wherein the image storage is adapted to store an image uploaded from the communication terminal via the network.

23. The image publishing system according to claim 22,
wherein the image publishing device further comprises a publishing/non-publishing controller adapted to control publishing/non-publishing of each of the images based on a decision on publishing/non-publishing made by the publishing/non-publishing decision unit.

24. The image publishing system according to claim 23,
wherein the publishing/non-publishing decision unit is adapted to add information on publishing/non-publishing of each of the images to Exif data of each of the images as tag information, and
wherein the publishing/non-publishing controller is adapted to control publishing/non-publishing of each of the images based on the tag information on each of the images.

25. The image publishing system according to claim 24,
wherein the communication terminal includes a monitor adapted to display an image which the publishing/non-publishing decision unit has decided to publish or not to publish, and
wherein the publishing/non-publishing decision unit is adapted to store, as the tag information, information on publishing/non-publishing of each of the images on which the user has finally decided by viewing the image on which a decision on publishing or non-publishing has been made and which is displayed on the monitor.

26. The image publishing system according to claim 25,
further comprising a database adapted to store a user's preferences based on information on a user's final publishing/non-publishing decision,
wherein the publishing/non-publishing decision unit is adapted to decide to publish or not to publish each of the images based on the user's preferences stored in the database.

27. The image publishing system according to claim 24,
wherein the publishing/non-publishing decision unit is adapted to store user identification as the tag information in addition to the information on publishing/non-publishing and use the user identification to perform control such that a second user is prohibited from changing information on publishing/non-publishing on which a first user has decided.

28. The image publishing system according to claim 22,
wherein the communication terminal includes a GPS function adapted to obtain information on location of the communication terminal, and
wherein the publishing/non-publishing decision unit is adapted to set conditions for restricting publishing of each of the images based on the information on location.

29. An image publishing method comprising:
an image storing step of storing images owned by a user in an image storage,
an image analysis step of performing image analyses on each of the images stored in the image storage, and
a publishing/non-publishing decision step of making a publishing/non-publishing decision on each of the images based on results of the image analyses made on each of the images.

30. A non-transitory computer readable recording medium having recorded thereon a program adapted to cause a computer to execute each step of the image publishing method according to claim 29.
